(19) United States
(12) Patent Application Publication
(10) Pub. No.: US 2004/0031553 A1
(43) Pub. Date: Feb. 19, 2004

(54) DEVICE AND METHOD FOR PROTECTING A SURFACE

(75) Inventor: Russell Berger, Needham, MA (US)

Correspondence Address: BARLOW, JOSEPHS & HOLMES, LTD., 101 DYER STREET, 5TH FLOOR, PROVIDENCE, RI, 02903, US

(73) Assignee: Ms. Constance F. Berger, Naples, FL (US)

(21) Appl. No.: 10/250,057

(22) Filed: Jun. 1, 2003

Related U.S. Application Data
(60) Provisional application No. 60/403,741, filed on Aug. 15, 2002.

(51) Int. Cl. B32B 31/00

(52) U.S. Cl. 156/71; 156/60

(57) ABSTRACT

A method of protecting a surface of an object includes the steps of first providing an object having a surface to be protected. The device used to carry out the method has a substrate with a first side and a second side. An array of elements are disposed on the first side of the substrate. The device is adhered to the surface to be protected by adhesive on the second side of the substrate. The surface to be protected is now covered with an array of protective elements that resiliently deflect a body part, such as a finger, that impacts into the free ends of the elements. The protective elements create discomfort in the body part thereby deterring a person from allowing future impact by the body part into the free ends of the elements and the surface to be protected thereby.

### CROSS REFERENCE TO RELATED APPLICATIONS

This application claims the benefit of U.S. Provisional Application 60/403,741 having a filing date of Aug. 15, 2002.

### BACKGROUND OF INVENTION

The present invention relates to methods of protecting a surface on an object and deterring a person from contacting such a surface. More specifically, the present invention relates to a device and method for deterring a child from touching or pressing a surface, such as a button or knob, to protect that surface.

It is well known that children, particularly very young children, are very curious and have a particular desire to explore their surroundings. They are also reluctant to sit still for long periods of time. As a result, such young children are typically interesting manipulating various buttons, latches, knobs and other objects in their environment. These children quickly learn to manipulate these items to open and unlock doors, unlatch security devices and unlock seat belts.

For example, a child residing in a car seat is commonly secured therein with a seat belt using a belt buckle latch arrangement. This belt buckle typically includes a female receptacle end with a press button and a male end. The male end is inserted into the female receptacle to secure the seat belt in place in the usual fashion. After a period of time being belted into the vehicle, a child often becomes restless and desires to move about the vehicle. A child quickly learns that he or she may simply press the large button on the female end of the belt buckle to unlock the belt thereby freeing him or herself therefrom. This is particularly troublesome when the child is residing in a child car seat where the child seat itself is secured in place by the locked seat belt. As can be understood, a loose child within the cabin of a vehicle presents a safety hazard. In this example, there would be a desire to provide a locking mechanism that can only be unlocked by an adult to prevent the child from unlocking the seat belt buckle. However, such a lock would pose a safety concern if an accident were to occur because such unlocking would delay removal of the child for the seat belt in an emergency. Further, such a locking device could fail in such an emergency situation.

Also, there is a desire to protect other surfaces, such as a door knob or door handle. Since children have a desire to open doors to explore their surroundings, there is a need to discourage a child from touching a door knob or door handle.

Attempts have been made in the prior art to discourage a child from touching a surface, such as a door knob. For example, slip covers have been provided for a door knobs or a stove knob to make it difficult for a child to grip the knob to turn it. In addition, various mats and pads have been provided in the prior art to protect a given surface, such as the hood of a car, from access by an animal, such as a cat.

These prior art attempts are inadequate for protecting various dangerous surfaces and buttons that can be accessed by a child, such as the button of a car seat belt buckle. These prior art devices and methods are inadequate because they are not appropriate for exposure to a child and cannot be properly adhered to the desired surface to be protected.

In view of the foregoing, there is a demand for a method and device that protects the surface of an object and discourage a person from touching and manipulating it. There is a demand for a device that can be easily installed onto a surface to be protected. There is a further demand for a device and method for protecting a surface that does not alter the function or operation of the object with which it is associated. There is also a demand for a method and device that can be easily configured to accommodate the size and shape of the surface to be protected. There is a demand for a method and device that can protect a surface and deter a person from touching the surface without injuring the person who may touch the surface protection device. There is a further need for a method and device to teach a person to not touch a given surface or press or turn a certain button, lever or knob that may be dangerous to that person.

### SUMMARY OF INVENTION

The present invention preserves the advantages of prior art methods for protecting the surfaces of objects and devices for carrying out such methods. In addition, the method and device of the present invention provides new advantages not found in currently known methods and devices and overcomes many disadvantages of such currently available methods and devices.

The present invention is generally directed to a method of protecting a surface of an object that includes the steps of first providing an object having a surface to be protected. The device used to carry out the method has a substrate with a first side and a second side. An array of elements are disposed on the first side of the substrate. The device is adhered to the surface to be protected by adhesive on the second side of the substrate. The surface to be protected is now covered with an array of protective elements that resiliently, or at least partially resiliently, deflect a body part, such as a finger, that impacts into the free ends of the elements. The protective elements create discomfort in the body part thereby deterring a person from further continuance and, perhaps, future impact by the body part into the free ends of the elements and the surface to be protected thereby.

In accordance with the method of the present invention, the device for carrying out the invention is adhered to a surface of an object to be protected. For example, a button of a seat belt buckle, stove knob, household electrical outlet cover or a door knob may be such a surface that may be protected. The release paper on the device is removed to reveal the adhesive on the contact surface thereof. The device is then pressed onto the surface to be protected so that the adhesive will retain the device in place. The device will then cover the surface to be protected with the array of elements. When a person, such as a child, attempts to touch the surface, they will experience discomfort due to the contact with the free ends of the elements. Such discomfort will deter future contact by the child thereby protecting the surface. More specifically, the device may be placed on the top surface of the button of a seat belt buckle to deter the child from pressing it.

Accordingly, it is a primary object of the instant invention to provide a method of protecting a surface of an object.

Another object of the instant invention is to provide a method of deterring contact with a surface of an object.

Still further, an object of the instant invention is to provide a method of protecting a surface that uses a device that easily adheres to a surface to be protected.

It is yet another object of the present invention to provide a method of protecting a surface that uses a device that provides discomfort to a person that touches it yet does not harm that person.

A further object of the present invention is to provide a method protecting a surface that uses a device that can be provided in different sizes to accommodate and protect surfaces of different sizes.

### BRIEF DESCRIPTION OF DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which.

FIG. 1 is a perspective view of the preferred embodiment of the device using in connection with the method of protecting a surface in accordance with the present invention;

FIG. 2 is a front elevational view of the device shown in FIG. 1;

FIG. 3 is a perspective view of the device of FIG. 1 applied to a surface to be protection in accordance with the method of the present invention;

FIG. 4 is a side elevational view of the device of FIG. 1 in the process of protecting a surface in accordance with the method of the present invention; and

FIG. 5 is a side elevational view of an alternative embodiment of a device that can be used in connection with the method of the present invention.

### DETAILED DESCRIPTION

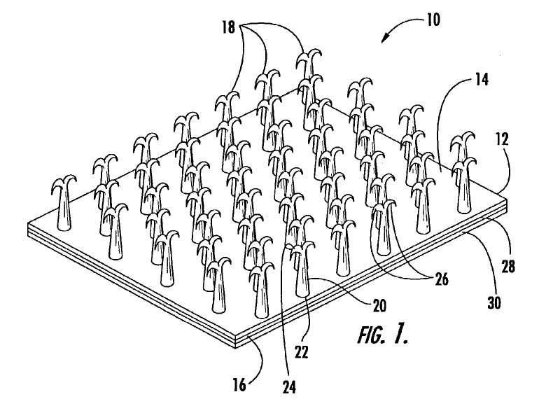

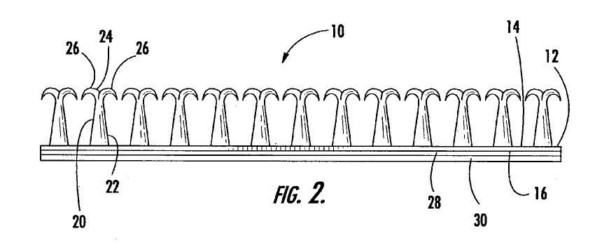

Referring first to FIGS. 1 and 2, the device 10 used in accordance with the present invention is shown. A substantially planar substrate 12 is provided with a top surface 14 and a bottom surface 16 with a predetermined plan area. The substrate 12 is provided with an array of contact elements 18 thereon. Each of the contact members 18 include a main body 20 with a bottom mounting end 22 and a top free end 24. In the preferred embodiment of FIGS. 1 and 2, the contact members 18 include a stalk-like configuration where the bottom mounting end 22 is smaller than the top free end 24. The top free end 24 of each of the contact members 18 is generally in the form a mushroom shape with a pair of opposing flaring members 26 emanating therefrom. In this preferred embodiment, the mounting end 22 has a generally smaller plan area than the top free end 24.

The substrate 12 and contact elements 18 are preferably made of a semi-flexible plastic material for ease of construction but may be of other formable, flexible or rigid materials. For example, the substrate 12 and elements 18 may be injection molded from a unitary mold. Alternatively, the substrate 12 and contact elements 18 may be separate members instead which are adhered to one another. Further, element 18 (in its entirety) may either be manufactured and constructed in one process and with one material, or the indivual structural components of 18 (20, 26, 22) may each or in total be manufactured from more than one material and in more than one manufacturing process and combined later to form the unified element 18.

The present invention is also provided with a structure to facilitate the affixation of the device 10 to a surface to be protected. Preferably, adhesive 28 is provided on the bottom surface 16 of the substrate 12 for this purpose. Release paper 30 is provided on the adhesive 28 to protect it until the device 10 is ready to be adhered to a surface. Details of adhesives and release papers therefor need not be discussed in detail herein as they are well known in the prior art.

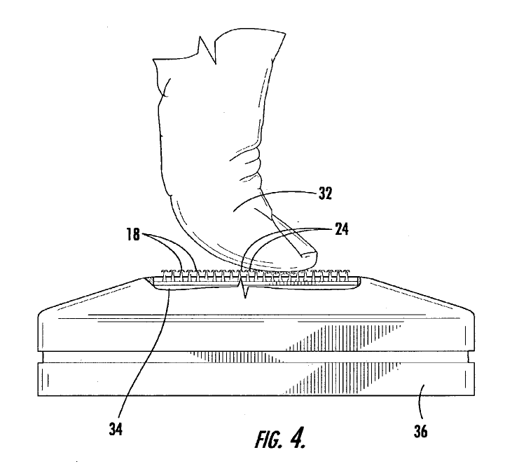

The contact members 18 are manufactured of a material such as the plastic described above, or from a combination of materials, resulting in a total member that is substantially resilient yet rigid to the touch. The unique mushroom shape of the elements 18 of the device 10 of the present invention provides a rounded, cushioned top surface 24 that is created by the two flaring members 26. However, the main body 20 of the contact elements 18 is rigid thereby resisting impact made by a body part 32 of a person. As will be described in detail in connection with FIG. 4, the contact elements 18 are selected to be of a configuration that provides a level of discomfort to a person touching them without actually injuring them. Formation of the top free end 24 with a contact area that is larger than the plan area of the mounting end 22 enables the main body 20 to bend and flex to provide the aforesaid discomfort while still providing a broadened and cushioned top contact surface 24 to prevent injury.

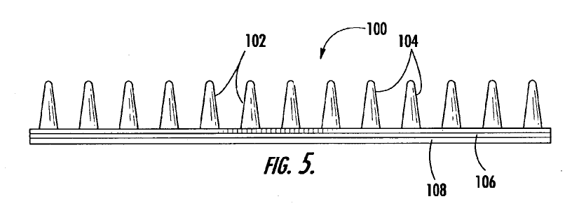

It should be understood that the configuration of the contact elements 18 shown in FIGS. 1 and 2 is just one structure to carry out the present invention. The contact elements 18 in the array are preferably even spaced and of the same construction. However, it is possible that the contact elements 18 may be unevenly spaced across the top surface 14 of the substrate 12 and/or be of a different configuration. For example, pin-like contact elements 102, as those seen in FIG. 5, may be interdispersed within the array of mushroom-shaped contact elements 12 of FIGS. 1 and 2. The flexibility of the contact elements 12 may set to provide a desired level of rigidity to deliver the appropriate amount of discomfort to the body part 32.

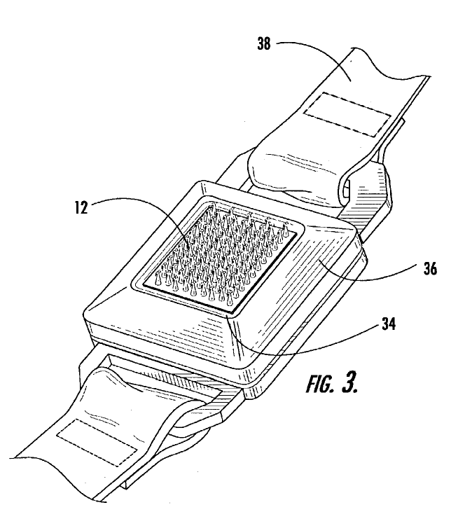

Moreover, the substrate 12 is illustrated in FIGS. 1 and 2 as being of a four-sided, substantially square shape. It is also possible, which is fully within the scope of the present invention, to form the substrate 12 of different shapes, such as circles, ovals, octagons, and the like, to suit the surface to be protected, such as the button 34 of seat belt buckle 36 of FIG. 3. The shape of the substrate 12 can also be custom shaped to match the shape of a surface 34 to be protected. Also, the substrate 12 can be configured to be flexible as well to accommodate non-flat surfaces, such as the sides of a door knob, when affixed thereon.

Referring now to FIGS. 3 and 4, an example of use of the method and device 10 of the present invention is shown in detail. The present invention is shown to protect the exposed surface of a button 34 of a seat belt buckle 36 to prevent a child from pressing that button 34 to release unlock their seat belt 38. In this example, the device 10 is configured into a substantially square shape to fit closely to the plan area of the top surface of the button 34. To install the device 10 in accordance with the method of the present invention, the release paper 30 on the bottom of the device 10 is removed to expose the adhesive 28. The device 10 is then pressed onto the top surface of the button 34 to adhere it thereto. As shown in FIG. 3, the device 10 is then secured affixed to the surface to be protected, namely, the top surface of the button 34 of seat belt buckle 36.

With the device 10 installed on the desired surface, any impact to that surface by a body part 32 will cause the aforesaid mild discomfort to the person to, in turn, discourage that person from contacting the surface again. FIG. 4 illustrate the contact of the top free ends 24 of the contact elements 18 which deflect slightly to not cause injury to the body part 32 while still providing the necessary level of mild discomfort. It should be understood that the discomfort delivered by the contact elements 18 is typically only felt by body parts 32 that are sensitive, such as those of a young child. It is highly likely that an adult will not feel any discomfort at all from the contact elements 18.

Therefore, in the example of FIGS. 3 and 4, a parent can prevent. and deter a child from pressing the button 34 of the seat belt buckle 36 to, in turn, prevent the child from roaming about the cabin of a vehicle. However, when the parent wishes to remove the child from the vehicle, the button 34 of the belt buckle 36 can be easily and quickly pressed by the parent in the usual fashion without a problem.

Turning now to FIG. 5, a device 100 of an alternative embodiment is shown which can be used in the method of the present invention. In this embodiment, the contact elements 104 are pin-like in configuration rather than of a mushroom-shape as in FIGS. 1-4. These pin-like contact elements 104 may be preferred in certain applications due to the shape thereof. For example, these pin-like elements 104 may be employed to deliver a different level and type of discomfort to the body part 32 that contacts them. As stated above, these pin-like elements 104 may also be interdispersed within an array of mushroom-shaped elements 18 of the preferred embodiment. The flexibility of the pin-like elements 104 may set to provide a desired level of rigidity to deliver the appropriate amount of discomfort to the body part 32.

In similar fashion to the device 10 of the preferred embodiment of the present invention, the device 100 of the alternative embodiment also includes a layer of adhesive 106 on the bottom surface thereof and protective release paper 108 that can be removed when it is ready to be affixed onto the surface to be protected.

It should be understood that the mushroom-shaped contact elements 18 of the device 10 of the preferred embodiment and the pin-like elements 102 of the alternative embodiment 100 are just two configurations that can be employed in accordance with the present invention. The contact elements 18, 102 can be formed of other shapes and configurations and still be within the scope of the present invention. For example, the contact elements 18 can be constructed and configured, in any manner whereby the horizontal plane of the top surface 26 in any linear dimension or in total surface area is either substantially similar to, or is in any way greater than, any part of the main body 20 or its base 22. As well, the contact elements 18 can be constructed or configured in any manner (for example a shape roughly that of an upside-down “U”) whereby the horizontal plane of the top surface 26 in any linear dimension or in total surface area is either substantially similar to, or slightly less than, any part of the main body 20 or its base 22. Also, the contact elements 18 can be constructed or configured in any manner (for example a shape roughly pyramidal in configuration) whereby the horizontal plane of the top surface 26 in any linear dimensions or in total surface area is substantially less than any part of the main body 20 or its base 22. Further someone skilled in the art may wish to combine in any manner or configuration an array of contact elements 18 that may differ in general shape, height, width and length and whereby each may be of similar or varying dimensions and shapes with regard to linear top surface 26 shape or dimensions, main body 20 shape or dimensions or base 22 shape or dimensions, as mentioned above, either in a designated or random pattern along the substrate 14.

As stated above, adhesive is preferred to adhere the device 10, 100 onto a surface to be protected. Any adhesive and release paper configurations in the prior art are suitable for the use in the present invention as long as they secured affix the device to the surface to be protected. It should be understood that other structures may be used to affix the device 10, 100 to a given surface. For example, the bottom surface 16 of the device 10 may be magnetized or a magnet may be affixed thereto to permit the device 10 to be magnetically attached to a metal surface. Also, in certain environments, the base 12 of the device 10 may be made of a material to enable affixation to a given surface by static cling. Others types of connections are considered to be within the scope of the present invention.

1. A method of protecting a surface of an object, comprising the steps of:
providing an object having a surface to be protected; providing a substrate having a first side and a second side; providing an array of elements disposed on the first side of the substrate; each of the elements including a main body with a mounting end at one end and a free end at the opposing end; the mounting end being in communication with the first side of the substrate;
providing an adhesive on the second side of the substrate; placing the second side of the substrate on the surface to be protected with the adhesive residing therebetween; adhering the second side of the substrate to the surface to be protected;
resiliently deflecting a body part that impacts into the free ends of the elements; creating discomfort in the body part; and deterring future impact by the body part into the free ends of the elements and contact with the surface to be protected.

2. The method of claim 1, wherein each of the elements include a base that has a plan area that is smaller than the plan area of the free end thereof.

3. The method of claim 1, wherein each of the elements have a free end that is substantially mushroom in shape.

4. The method of claim 1, wherein each of the elements include a base that has a plan area that is greater than the plan area of the free end thereof.

5. The method claim 1, wherein the free end of each of the elements is pointed.

6. The method of claim 1, wherein the main body is flexible.

7. The method of claim 1, further comprising the step of:
connecting at least one flared contact members to the free end of each of the elements.

8. The method of claim 7, wherein the at least one flared contact members is a pair of contact members which flare away from each other thereby providing a top contact surface.

9. A device for protecting a surface of an object, comprising:
an object having a surface to be protected;
a substrate having a first side and a second side;
an array of elements disposed on the first side of the substrate; each of the elements including a main body with a mounting end at one end and a free end at the opposing end;
the mounting end being in communication with the first side of the substrate; the free ends of the elements being resiliently deflectable upon impact of a body part;
whereby the free ends creating discomfort in the body part upon such impact thereby deterring future impact by the body part into the free ends of the elements and contact with the surface to be protected.

10. The device of claim 9, wherein each of the elements include a base that has a plan area that is smaller than the plan area of the free end thereof.

11. The device of claim 9, wherein each of the elements have a free end that is substantially mushroom in shape.

12. The device of claim 9, wherein each of the elements include a base that has a plan area that is greater than the plan area of the free end thereof.

13. The device claim 9, wherein the free end of each of the elements is pointed.

14. The device of claim 9, wherein the main body is flexible.

15. The device of claim 9, further comprising:
at least one flared contact members connecting to the free end of each of the elements.

16. The device of claim 15, wherein the at least one flared contact members is a pair of contact members which flare away from each other.
